(19) United States
(12) Patent Application Publication
(10) Pub. No.: US 2010/0187135 A1
(43) Pub. Date: Jul. 29, 2010

(54) Bag with Leak Resistant Features

(76) Inventors: Shaun T. Broering, Fort Thomas, KY (US); Cathy Lynn Isakson, Cincinnati, OH (US); Nancy Mack-Robles, Bolingbrook, IL (US); Michael Scott O'Hara, Burbank, IL (US); Richard M. Hnat, New Lenox, IL (US); Matthew W. Waldron, Hamilton, OH (US); Bryn Hird, Cincinnati, OH (US)

Correspondence Address: THE CLOROX COMPANY, P.O. BOX 24305, OAKLAND, CA, 94623-1305, US

(21) Appl. No.: 11/916,224

(22) PCT Filed: May 31, 2006
(86) PCT No.: PCT/US06/20759

§ 371 Date: Feb. 26, 2008

Related U.S. Application Data
(60) Provisional application No. 60/689,249, filed on Jun. 10, 2005.

(51) Int. Cl. B65D 81/26; B65D 30/02; B31B 39/00

(52) U.S. Cl. 206/204; 206/524.2; 206/524.3; 493/210; 383/109

(57) ABSTRACT

A bag with flexible sidewalls defining an interior volume is provided with leak resistant features that function to absorb and retain liquids. These features include an absorbent-adhesive mixture that may be made from an adhesive and absorbent agents such as a super absorbent polymer. The absorbent-adhesive mixture can be applied on an inner surface of the flexible sidewalls in a location where it is likely to encounter liquids. The leak resistant features can also include a substrate that may be made from a non-woven material that is also applied to the inner surface of the sidewall and can be bonded to the sidewall by the absorbent-adhesive. In various embodiments, the bag can also include odor neutralizing features and/or configured with stretchable sidewalls.

### FIELD OF THE INVENTION

This invention pertains generally to bags for holding matter and more particularly to bags adapted to be substantially leak proof. The invention finds particular applicability in the fields of garbage collection and food storage.

### BACKGROUND OF THE INVENTION

The many styles of flexible bags serve a wide variety of applications in the modern world. For example, one common use of bags is as liners for garbage cans and similar refuse containers. These refuse containers that employ liners can be found at many locations from small household kitchen garbage cans to larger, multi-gallon drums located in public places and restaurants. Bags that are intended to be used as liners for such refuse containers are typically made from low-cost, pliable thermoplastic material. The liquid impervious nature of the thermoplastic material is highly desirable for retaining liquids and juices that are often the by-products of discarded garbage. Still, leaks may develop even in the sturdiest of bags due to puncturing of the thermoplastic sidewall material or failure at the seams. Such leakage, as will be appreciated, allows liquids to drain to the bottom of the garbage can or directly onto the floor or ground when the bag is being removed.

Another common use for flexible bags is in the field of food storage. Again, such bags are typically made of a pliable thermoplastic material where the liquid impervious nature of the thermoplastic material helps retain liquids and juices that may be associated with the stored food items thereby both preserving the food items and avoiding messes arising from leakage. Of course, because of particularly harsh applications or through common wear and tear, storage bags used in the food industry may still develop leaks undermining the foregoing accomplishments.

### BRIEF SUMMARY OF THE INVENTION

The invention provides a bag adapted for improved leak resistance. The bag includes a flexible sidewall that provides the interior volume. To absorb and retain liquids from items stored in the bag, the bag includes an absorbent-adhesive mixture comprised of an absorbent agent such as a super absorbent polymer that is capable of absorbing and retaining many times its own weight in fluids and can be located in a suitable position within the bag. In addition to the absorbent agent, the absorbent-adhesive mixture can also include an adhesive that helps the mixture remain attached to the bag even when expanding with absorbed liquids. Attachment is beneficial to capture liquids so they do not bypass the absorbent materials.

For additional liquid absorption, the bag can also include a substrate made out of a material such as a non-woven material. The absorbent-adhesive mixture can be applied between the flexible sidewall of the bag and the substrate to attach the two together. Thus, in an aspect, the invention provides a multilayered construction including a pliable sidewall, an absorbent-adhesive mixture, and a substrate. The materials of the absorbent agent and the substrate can be selected to absorb and retain different liquids and thereby improve the leak resistance of the bag.

In further aspects, the bag can include additional features such as odor-neutralizing compositions to reduce or eliminate odors, including foul odors, that may be emitted by the bag's contents. Another possible feature for inclusion is that the sidewalls of the bag can be configured to stretch in order to accommodate objects without ripping or tearing during insertion, thereby further avoiding potential leakage.

Hence, an advantage of the invention is that it provides a thermoplastic bag that is adapted to absorb liquids and thereby avoid leaking. Another advantage is that, in another aspect, the bag can include odor-neutralizing compositions to combat odors that may be generated by the contents of the bag. These and other advantages and features of the invention will become apparent from the detailed description and the accompanying drawings.

### BRIEF DESCRIPTION OF THE DRAWINGS

FIG. 1 is a perspective view of a bag equipped with an absorbent-adhesive mixture and a substrate positioned in the bottom of the bag for reducing leakage and also equipped with a draw-tape for closing the opening.

FIG. 2 is a cross-sectional view taken along line 2-2 of FIG. 1.

FIG. 3 is a detailed view taken of the area indicated in FIG. 2 showing the flexible bag sidewall, the absorbent-adhesive mixture, and the substrate material arranged in layers.

FIG. 4 is a detailed perspective view of the area indicated in FIG. 4 illustrating one type of suitable material for providing the bag with a stretchable or yieldable characteristic, the material being in a substantially un-stretched condition.

FIG. 5 is a detailed perspective view of the area indicated in FIG. 1 illustrating the suitable material being in a partially-stretched condition.

FIG. 6 is a cross-sectional view similar to that taken along line 2-2 of FIG. 1 showing another embodiment of the bag having an absorbent agent positioned in the bottom of the bag.

FIG. 7 is a cross-sectional view similar to that taken along line 2-2 of FIG. 1 showing another embodiment of the bag having an absorbent-adhesive mixture in the bottom of the bag.

FIG. 8 is a perspective view of another embodiment of a bag equipped with an absorbent-adhesive mixture and a substrate positioned as strips across a sidewall, the bag further including gusseted side edges and a gusseted bottom edge.

FIG. 9 is a perspective view of another embodiment of a bag equipped with an absorbent-adhesive mixture and a substrate positioned as a strip across the middle of the first sidewall, the bag further including tie flaps for closing the opening.

FIG. 10 is a perspective view of another embodiment of a bag equipped with an absorbent-adhesive mixture and a substrate positioned as a strip along the bottom of the bag and spaced-apart from the side edges.

FIG. 11 is a perspective view of another embodiment of a bag equipped with an absorbent-adhesive mixture and a substrate positioned as a patch against a sidewall.

FIG. 12 is a schematic view of a bag manufacturing environment for processing bags that are to include an absorbent-adhesive mixture and a non-woven material.

### DETAILED DESCRIPTION OF THE EMBODIMENTS

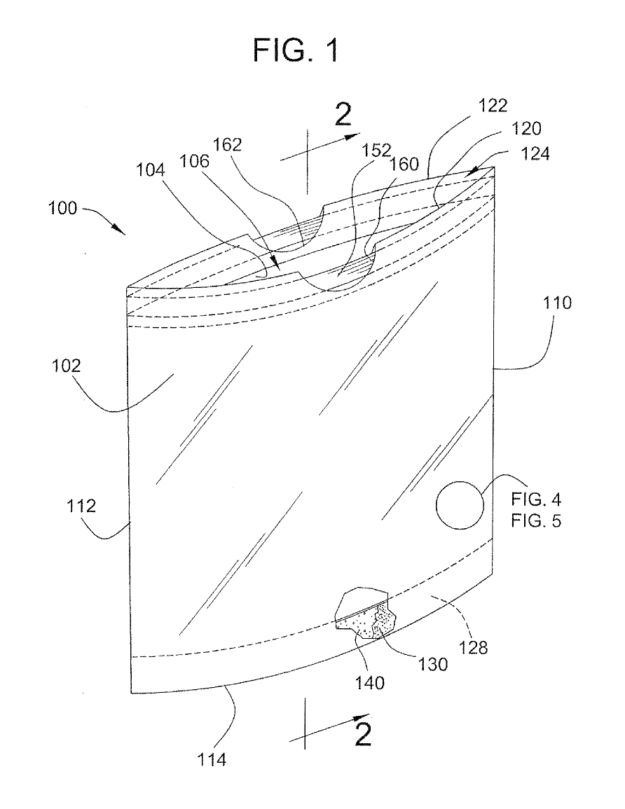

Now referring to the drawings, wherein like reference numbers refer to like elements, there is illustrated in FIG. 1 an embodiment of a flexible bag 100. While flexible bags are generally capable of holding a vast variety of different contents, the specific bag 100 illustrated in FIG. 1 is intended to be used as a liner for a garbage can or similar refuse container. The bag 100 is made from a first sidewall 102 and an opposing second sidewall 104 overlying the first sidewall to provide an interior volume 106 therebetween. The first and second sidewall 102, 104 are joined along a first side edge 110, a parallel or non-parallel second side edge 112, and a closed bottom edge 114 that extends between the first and second side edges. The first and second sidewalls 102, 104 are preferably made of flexible or pliable thermoplastic material formed or drawn into a smooth, thin walled web or sheet. Examples of suitable thermoplastic material include high density polyethylene, low density polyethylene, linear low density polyethylene, polypropylene, ethylene vinyl acetate, nylon, polyester, ethylene vinyl alcohol, and can be formed in combinations and in single or multiple layers. When used as a garbage can liner, the thermoplastic material will typically be opaque but in other applications can be transparent, translucent, or tinted. Furthermore, the material used for the sidewalls can be a gas impermeable material. The sidewalls 102, 104 can be joined along the first and second side edges 110, 112 and bottom edge 114 by any suitable process such as, for example, heat sealing. For accessing the interior volume 106 to, for example, insert refuse or garbage, the top edges 120, 122 of the first and second sidewalls 102, 104 remain un-joined to define an opening 124.

To absorb and retain liquids and juices that often are contained in or the by-product of inserted garbage, an absorbent-adhesive mixture 130 and a substrate 140 can be placed in the interior volume 106. In the illustrated embodiment, the absorbent-adhesive mixture 130 and the substrate 140 are combined into a layered strip 128 that is located along the closed bottom edge 114 where liquids and juices under the influence of gravity are likely to collect. Specifically, the absorbent-adhesive mixture 130 is provided as a thin layer immediately adjacent the thermoplastic sidewalls 102, 104 with the substrate 140 extending over and covering the absorbent-adhesive mixture. In other embodiments, however, the absorbent-adhesive mixture and the substrate can be applied separately and in different locations in the internal volume. The absorbent-adhesive mixture 130 and the substrate 140 function to absorb and retain the liquids that could otherwise leak through seams, punctures, or tears in the pliable sidewalls 102, 104, or spill out through opening 124.

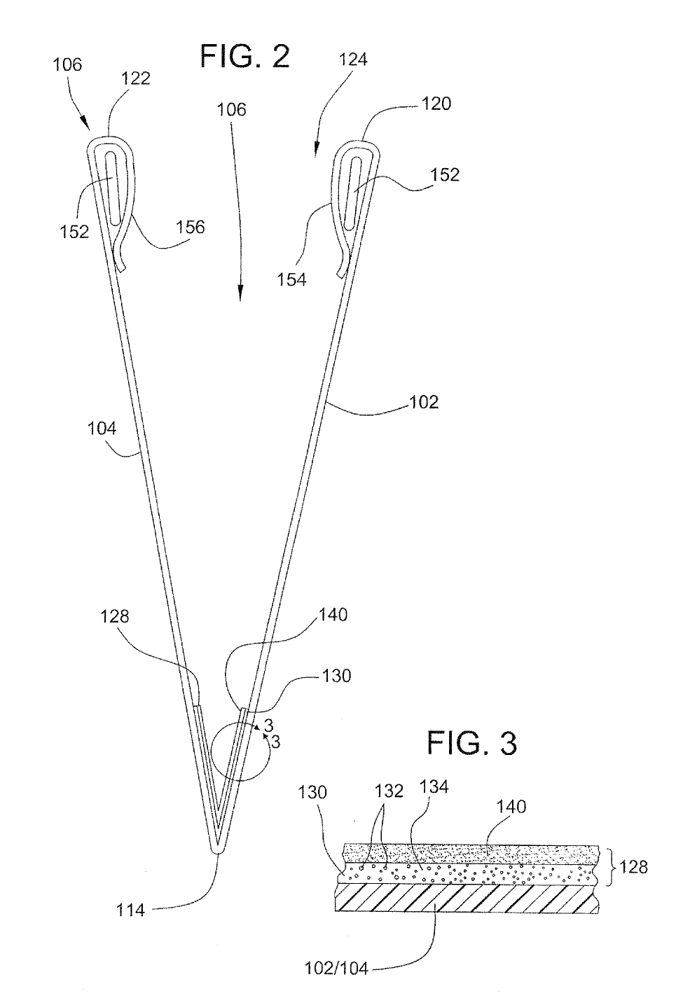

Referring to FIGS. 2 and 3, the absorbent-adhesive material 130 can be made by intermixing an absorbent agent, such as a super absorbent polymer, with an adhesive. A super absorbent polymer can absorb and retain many times its own weight in water. Super absorbent polymers and copolyers include, but are not limited to, partially neutralized hydrogel-forming gelling materials, such as polyacrylate gelling material and acrylate grafted starch gelling material for example potassium acrylate and sodium acrylate, sodium polyacrylate, solution polymers, and super absorbent fibers. Sodium polyacrylate, for example, is a hydrophilic polymer material that can hold up to 20 times its weight in water and, in some instances, up to 50 times its weight in water. Super absorbent polymers are typically available as particulates 132 or flake-like crystals that can be easily intermixed with and suspended in the adhesive 134. In other embodiments, instead of or in addition to the super absorbent polymer, the absorbent agent can be clay, silica, talc, diatomaceous earth, perlite, vermiculite, carbon, kaolin, mica, barium sulfate, aluminum silicates, sodium carbonates, calcium carbonates, absorbent gelling materials, creped tissue, foams, wood pulp, cotton, cotton batting, paper, cellulose wadding, sponges, and desiccants.

The adhesive 134 can be any suitable adhesive that demonstrates, at least initially, viscous properties that enable intermixing of the super absorbent polymer particles 132. The mixture of super absorbent polymers 132 and adhesive 134 forms a gel or paste that can be easily applied to the inner surfaces of the sidewalls. The adhesive should retain some fluid or elastic properties for an extended period of time to accommodate swelling of the super absorbent polymer that may occur during liquid absorption. Examples of suitable types of adhesive include hot-melt, natural or synthetic waterborne, solventborne, extrudable, and pressure sensitive adhesives, and multi-component glues. Other attachment devices may be used, such as, mechanical or chemical devices including tapes, two-sided tapes, hook and loop fasteners, hydrogen bonding, entrapment, heat sealing, and electrostatic charge.

The particular substrate 140 can be any suitable material. Examples of suitable substrate materials include non-woven materials made from natural or synthetic fibers including wood pulp, cotton, rayon, polyester, olefins such as, for example, polypropylene, polyethylene, nylon, or polyester and the non-woven material can be formed by any suitable operation including air laid, carded, wet formed, extrusion, using bonding methods such as chemical bond, mechanical bond, and thermal bond, and processes such as melt blown, spunbond, hydroentangled, needle punched, batting, through-air, calendar, saturation, dry-laid or wet-laid. In the illustrated embodiment, the non-woven material is provided as a flat, continuous, flexible substrate or strip that can be securely bonded by the absorbent-adhesive material 130 to the inner surface of the sidewalls along the closed bottom edge 116.

Like the super absorbent polymer 132, the non-woven substrate 140 also serves to absorb and retain fluids and juices that may be present in the bag 100. The non-woven substrate 140 can be selected or specially treated to absorb and retain certain liquids that are repulsed or exuded by the super absorbent polymer 132. For example, typically super absorbent polymers are highly hydrophilic but tend not to absorb oils or other complex liquids. The non-woven material can absorb and trap these oils and complex liquids in the interstices between the non-woven fibers and in the polymers. Hence, the combination of the absorbent-adhesive material 130 and non-woven material 140 within the bag 100 can therefore absorb and retain a variety of different liquids thereby reducing potential leakage of the same.

The non-woven substrate 140 also provides other advantageous features and purposes. For example, liquids encountering the non-woven substrate 140 can wick through the material so as to be distributed more evenly across the layer of absorbent-adhesive mixture 130. Additionally, the non-woven substrate 140 will provide support for the absorbent-adhesive mixture. More specifically, covering the layer of absorbent-adhesive mixture 130 with the non-woven substrate helps prevent the inner surfaces of the sidewalls 102, 104 from sticking to themselves or to any inserted contents because of the adhesive properties of the mixture. Furthermore, the added layers of absorbent-adhesive mixture(s) 130 and non-woven substrate(s) 140 provides the sidewalls with additional resistance to punctures, breaks, and abrasion.

In other embodiments, instead of utilizing a non-woven material, the substrate 140 can be made from other materials. For example, the substrate 140 can be made from a cellulous based material that similarly provides the absorbent properties and liquid distribution via wicking properties of a non-woven material. The substrate 140 can also be made from wovens, thermoplastic films including apertured films and coextruded films, modified films including embossed or apertured, laminations, and co-extrusions that offer similar supportive properties for the absorbent-adhesive mixture.

In the embodiments where the bags are intended for use as garbage can liners, it may be desirable to include odor neutralizing features to reduce malodorous smells generated from the contained garbage. Examples of odor neutralizing features are disclosed in U.S. patent application Ser. No. 10/717,099 (Publication No. US 2004/0134923), herein incorporated by reference in its entirety. The odor neutralizing features may positively function to absorb and thereby remove the molecules that cause the malodorous smells. Additionally or alternatively, the odor neutralizing features may themselves generate a pleasant fragrance or scent that masks odorous and malodorous smells generated by the garbage, in effect acting like a perfume. Additionally or alternatively, odor absorbers, controllers, inhibitors and synergistic combinations may be used. The materials that provide the odor neutralizing features may be applied to or included in the absorbent-adhesive mixture, the substrate or the thermoplastic sidewalls by any suitable method. Odor absorbers may include molecules possessing a certain structural configuration that enables them to absorb and thus eliminate a broad array of odoriferous molecules. Such materials include, for example, cyclodextrins, zeolites, activated carbon, kieselguhr, chelating agents, chitin, alkali metal carbonates and bicarbonates, metazene, chlorine dioxide, pH buffered materials such as carboxylic acids and the like. Some hydrogel-forming odor absorbing gelling materials, such a polyacrylate gelling material and acrylate grafted starch gelling material, are also useful and these materials also function as fluid absorbing materials. Odor inhibitors may include those components which interrupt the biological processes responsible for malodors, particularly the processes involving the decomposition of food wastes by bacterial and microbial activity. Odor inhibitors may include antimicrobial agents, chelants, and metallic salts. A synergistic combination may include a garbage bag with an odor-neutralizing composition including an odor-absorbing ingredient selected from the following group: cyclodextrin, activated charcoal, baking soda, absorbent gelling materials, zeolites, silica, and combinations thereof; a chelant; and, an antimicrobial agent.

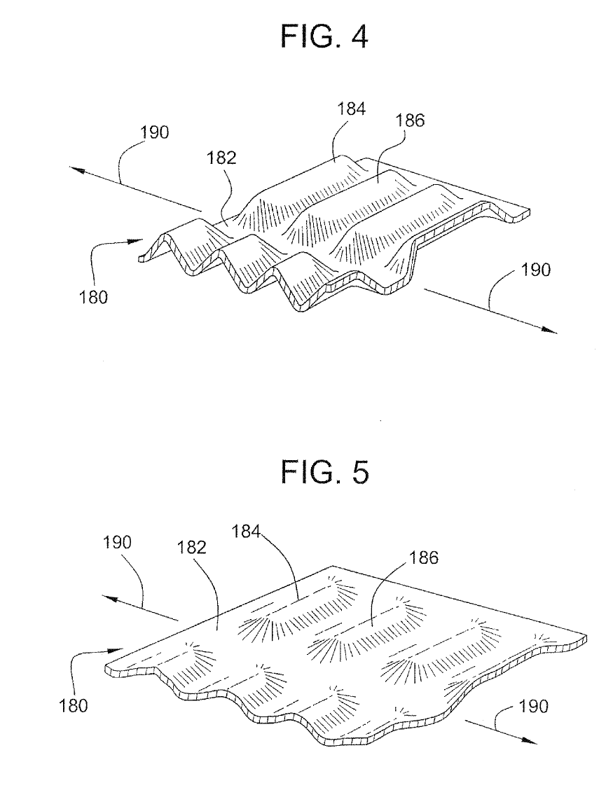

In further embodiments, the thermoplastic sidewalls of the bag can be configured to stretch or yield to accommodate cumbersome or bulky objects without puncturing, thereby further preventing leaks. Referring to FIGS. 4 and 5, a portion 180 of the sidewall material can have a “strainable network” that includes a plurality of first regions 182 and a plurality of second regions 184. The second regions 184 can be formed by embossing raised, rib-like elements 186 into the material so that the second regions and first regions appear bunched or contracted together in the un-tensioned state illustrated in FIG. 4. When a pulling force is applied, as indicted by the arrows 190 in FIG. 5, the rib-like elements 186 are able to unbend or geometrically deform so that the first and second regions 182, 184 become substantially coplanar with each other. As will be appreciated, this action stretches or elongates the material 180. In addition to accommodating bulky objects, the strainable networks provide shock dampening when objects are suddenly thrust or dropped into the bag.

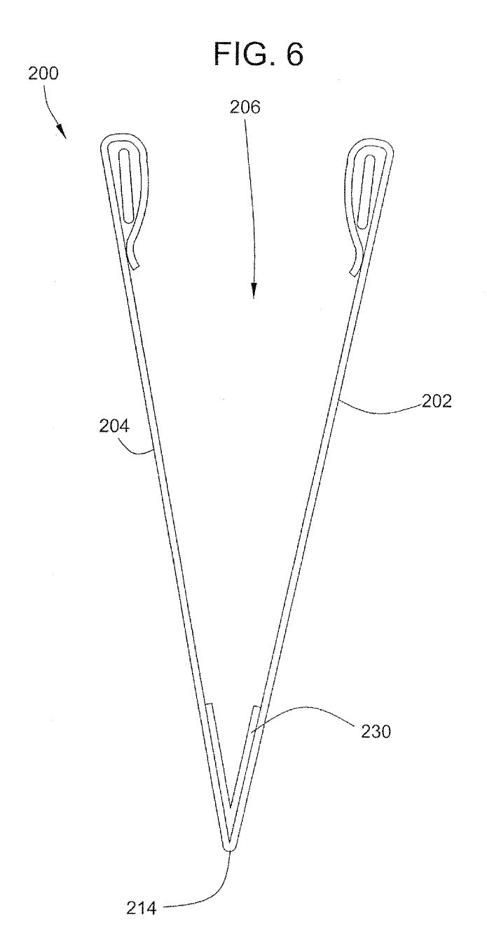

Referring to FIG. 6, there is illustrated another embodiment of a bag 200 having first and second flexible sidewalls 202, 204 joined at least along a closed bottom edge 214 to provide an interior volume. To absorb and retain liquids and juices that may be inserted into the bag 200, an absorbent agent 230 is positioned in the interior volume 206. In the illustrated embodiment, the absorbent agent 230 is located along the closed bottom edge 214 but in other embodiments could be located elsewhere in the interior volume 206. The absorbent agent can be any suitable agent including, for example, super absorbent polymers, clay, silica, talc, diatomaceous earth, perlite, vermiculite, carbon, kaolin, mica, barium sulfate, aluminum silicates, sodium carbonates, calcium carbonates, absorbent gelling materials, creped tissue, foams, wood pulp, cotton, cotton batting, cellulose wadding, sponges, and desiccants. Furthermore, the absorbent agent can be provided in any suitable form including a mat, sheet, block, or compressed composite.

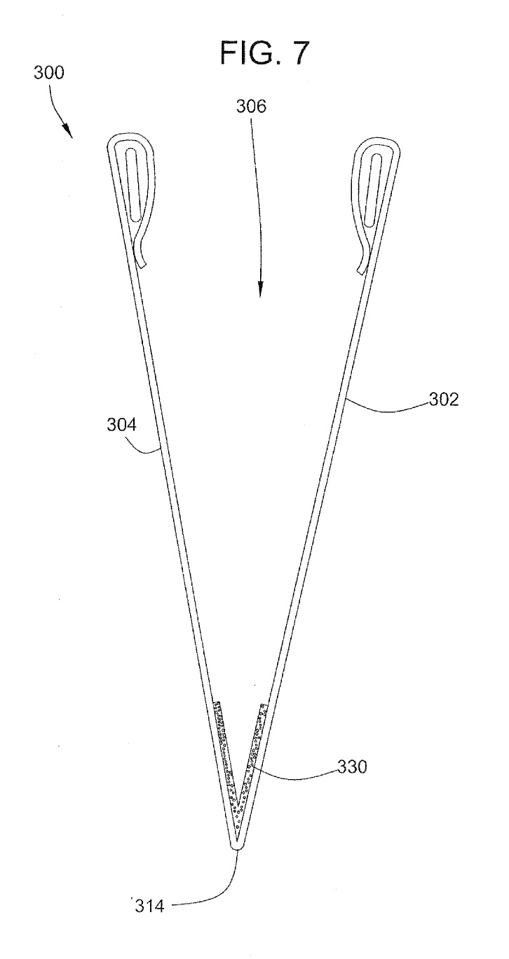

Referring to FIG. 7, there is illustrated another embodiment of a bag 300 having first and second flexible sidewalls 302, 304 joined along a closed bottom edge 314 to provide an interior volume. To absorb and retain liquids or juices that may be inserted into the interior volume 306, an absorbent-adhesive mixture 330 is placed in the interior volume 306. In the illustrated embodiment, the absorbent-adhesive mixture 330 is located along the closed bottom edge 314 but in other embodiments could be located elsewhere in the interior volume 306. The absorbent-adhesive mixture can be made from any combination of absorbent agents and adhesives described above. Furthermore, the absorbent-adhesive mixture 330 can be applied inside the bag in any suitable shape or manner including as a strip, a patch, or a pattern of strips and/or patches.

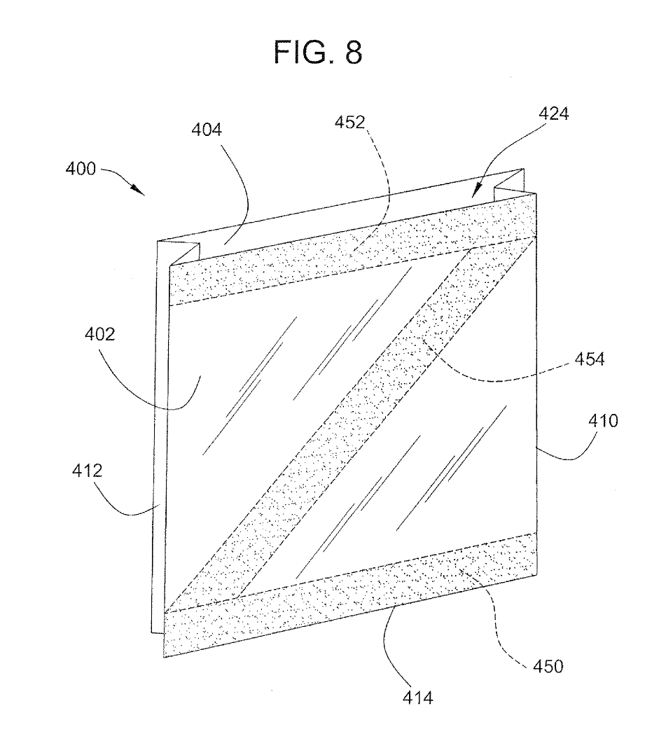

While for garbage can liners, it will generally be preferable to locate the absorbent-adhesive mixture and the substrate along the closed bottom edge of a bag where liquids will typical flow, when the bag is intended for other applications, the materials can be provided at any location within the bag where they are likely to encounter liquids. For example, referring to FIG. 8, an embodiment of the bag 400 intended for more general use such as storing and transporting food items. The bag 400 includes opposing first and second flexible sidewalls 402, 404 that, in addition to thermoplastic material, can be made from paper or a paper-like material. The first and second sidewalls 402, 404 are joined together to provide an internal volume 406 that is accessible through an opening 424 located at the top of the bag 400. In particular, the sidewalls 402, 404 are joined along a first side edge 410, a parallel second side edge 412, and a closed bottom edge 414 that extends between the first and second side edges. In the illustrated embodiment, the first side edge 410, second side edge 412, and closed bottom edge 414 are formed as gussets that allow the first and second sidewalls 402, 404 to be moved towards and away from each other thereby expanding and contracting the internal volume 406.

In the illustrated embodiment, the absorbent-adhesive mixture and substrate are provided as combined strips. As described before, a first strip 450 of combined materials is adhered to the first sidewall along the closed bottom edge 414 and extends between the first and second side edges 410, 412. However, a second strip 452 of the combined materials is provided proximately about the opening 424 of the bag 400. Additionally, a third strip of material 454 can be provided extending diagonally across the first sidewall 402 from the junction of the first side edge 410 and the opening 424 to the junction of the second side edge 412 and the closed bottom edge 414. In different embodiments of the bag, various combinations of strips and their locations can be included. For example, the bag may include only one strip of material extending across the opening or may include only one strip of material extending diagonally across the first sidewall.

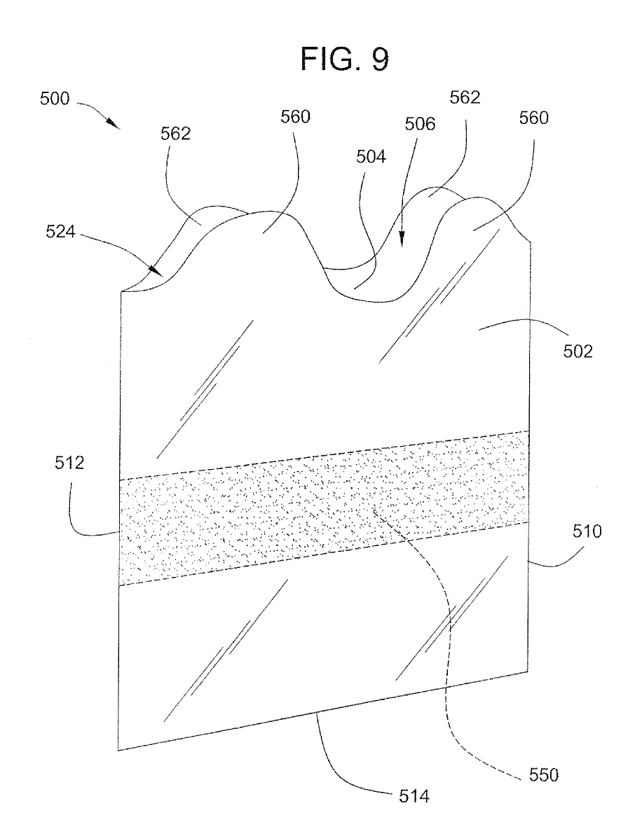

Another embodiment of a bag including an absorbent-adhesive mixture and a substrate is illustrated in FIG. 9. The bag 500 includes first and second sidewalls 502, 504 that are joined along parallel first and second side edges 510, 512 and a closed bottom edge 514 to provide an interior volume 506. To access the interior volume 506, there is disposed at the top of the bag 500 an opening 524. The absorbent-adhesive mixture and substrate are again provided as a combined strip 550 of material. However, in the illustrated embodiment, the combined strip 550 extends between the first and second side edges 510, 512 across the middle of the first sidewall 502 approximately half way between the opening 524 and the closed bottom edge 514.

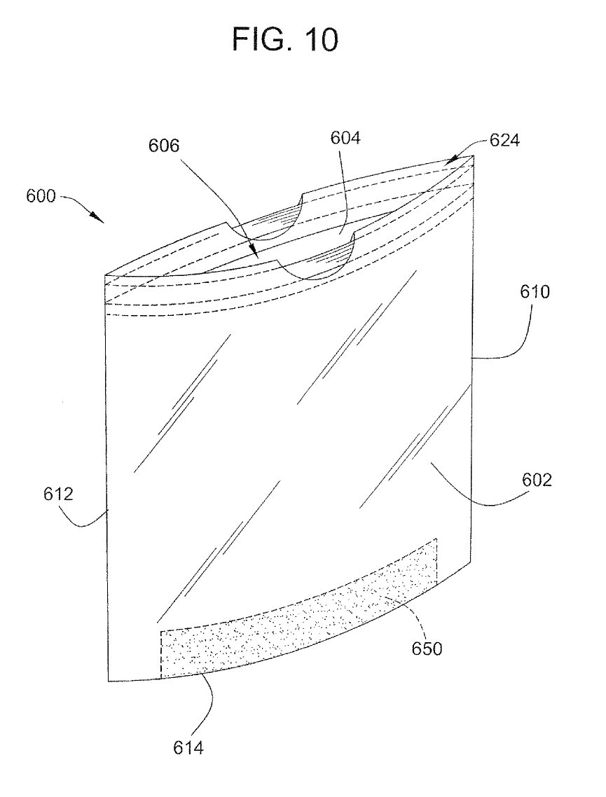

Another embodiment of a bag including an absorbent-adhesive mixture and a substrate is illustrated in FIG. 10. The bag 600 includes first and second sidewalls 602, 604 that are joined along parallel first and second side edges 610, 612 and a closed bottom edge 614 to provide an interior volume 606. To access the interior volume 606, there is disposed at the top of the bag 600 an opening 624. The absorbent-adhesive mixture and the substrate are provided as a combined strip 650 of material. In the illustrated embodiment, the strip 650 extends along the closed bottom edge 614 but is also spaced apart from the first and second side edges 610, 612. Hence, the length of the strip 650 is less than the width of the first sidewall 602. By having the strip 650 stop short of the first and second side edges 610, 612, the strip of combined material will not interfere with the joining operation employed to overlay and join the first and second sidewalls 602, 604.

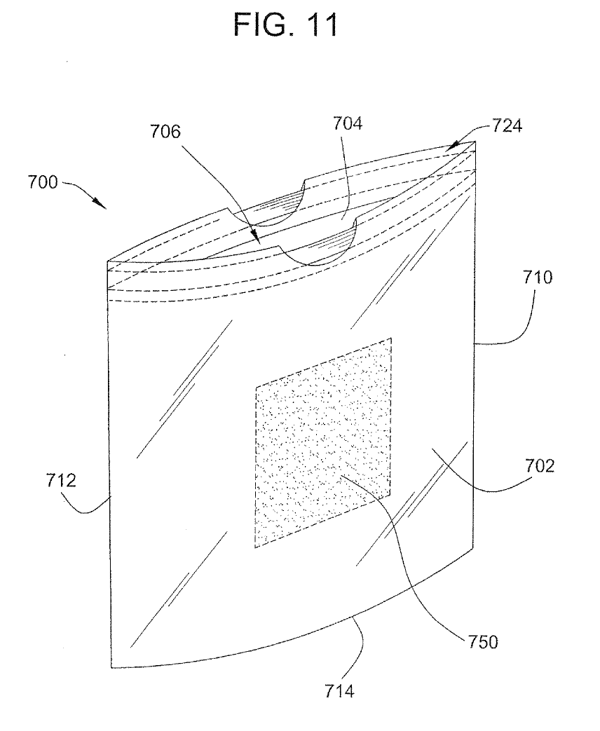

Another embodiment of a bag including an absorbent-adhesive mixture and a substrate is illustrated in FIG. 11. The bag 700 includes first and second sidewalls 702, 704 that are joined along parallel first and second side edges 710, 712 and a closed bottom edge 724 to provide an interior volume 706. To access the interior volume 706, there is disposed at the top of the bag 700 an opening 724. The absorbent-adhesive mixture and substrate are again provided as a combination of applied layers shaped as a patch 750 adhered to the first sidewall 702. Rather than extending along the side edges 710, 712 and bottom edge 714 of the bag though, the patch 750 is generally centered with respect to the first sidewall and spaced away from side edges and bottom edge.

The inventive bags may be provided with any of various closure mechanisms for closing the opening. For example, referring back to the embodiment illustrated in FIGS. 1 and 2, to close the opening 124 of the bag 100 when, for example, removing and disposing of the garbage can liner, the bag is fitted with a draw-tape 152. To accommodate the draw-tape 152, referring to FIG. 2, the first top edge 120 of the first sidewall 102 is folded back into the interior volume 106 and attached to an inner surface of the sidewall to form a first hem 154. The second top edge 122 is similarly folded back and attached to the inner surface of the second sidewall 104 to provide a second hem 156. The draw-tape 152, which is fixedly attached at the first and second side edges 110, 112, extends along the first and second top edges 120, 122 loosely through the first and second hems 154, 156. To access the draw-tape 152, first and second notches 160, 162 are disposed through the respective first and second top edges 120, 122. Pulling the draw-tape 152 through the notches 160, 162 will constrict the top edge 120, 122 thereby closing the opening 124.

Referring back to the embodiment illustrated in FIG. 9, different closing mechanisms such as tie flaps 560, 562 can be employed to close the opening 524 of the bag. The tie flaps 560, 562 are extensions of the material of the sidewalls 502, 504 that can be tied together when the bag 500 is to be removed and disposed of. In addition to tie flaps and draw-tapes, other suitable closing mechanisms include twist ties and mechanical clips. Furthermore, for securing the bag to a garbage container, an elastic strip may be attached about the opening of the bag which can be folded over so as to constrict about the rim of the container. In those embodiments where the bag is intended for use in applications besides garbage can liners, other suitable closure mechanisms can include interlocking fastening strips, low-tack or peelable adhesive, or various fold-top arrangements.

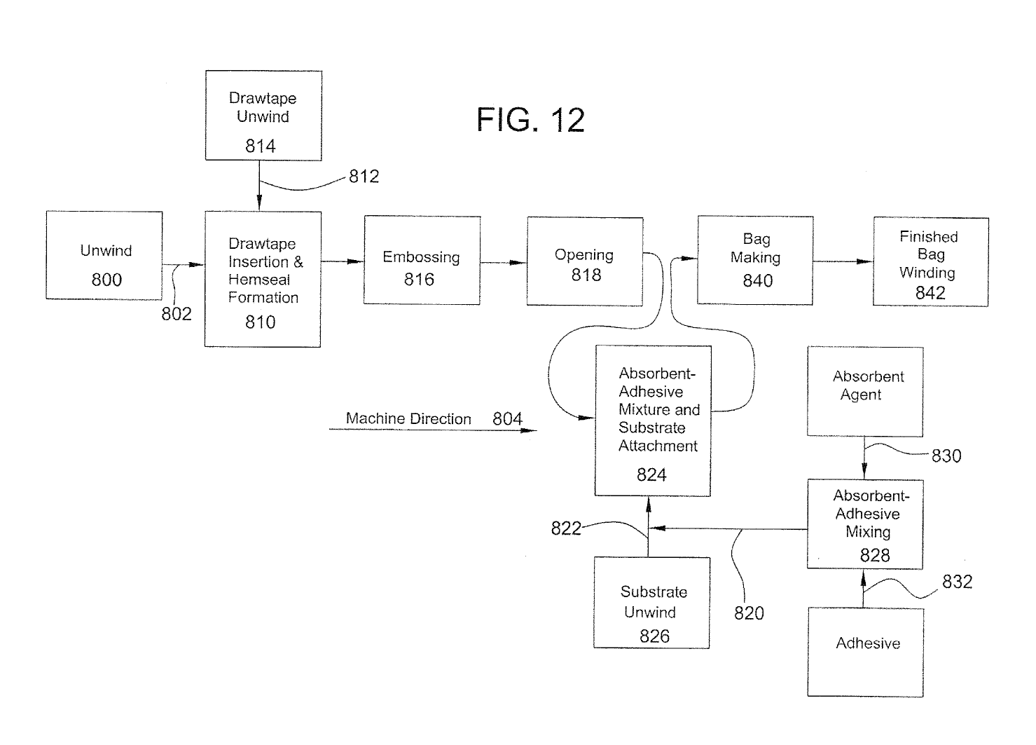

Manufacturing of a bag having an absorbent-adhesive mixture and a substrate can be accomplished in a high speed, semi-automated environment such as that illustrated in FIG. 12. Production begins in a first step 800 by unwinding a web 802 of thermoplastic sheet material and advancing the web along a machine direction indicated by arrow 804. In the illustrated environment, the web 802 is initially provided as a roll of material that is unwound from a core. However, in other manufacturing environments, the web can be initially provided in other forms or even extruded directly from a thermoplastic production operation.

In a subsequent step 810, the draw-tape 812 can be received into hemseals that are simultaneously formed into the web material 802. The draw-tape 812 itself can be provided as a continuous strip of material that is unwound at step 814 and aligned in the machine direction 804 prior to the hemseal formation step 810. After the inserting the draw-tape 812, to provide the web material 802 with a plurality of first regions and a plurality of second regions raised with respect to the first regions and thereby provide the web with an elastic quality, in step 816, the web material can be embossed or otherwise manipulated.

Next, the absorbent-adhesive mixture 820 and substrate material 822 can be attached to the advancing web in an attachment operation 824. If the web 802 has already been folded in half and joined together or a second web has been added and joined to the first web to provide the opposing first and second sidewalls of the finished bag, the attachment operation 824 can be preceded by a opening operation 818 wherein the sidewalls are separated to allow attachment of the materials. The substrate material 822 can be provided as a continuous strip of material that is unwound in an unwinding operation 826. The absorbent-adhesive mixture 820 is first prepared by mixing in a mixing operation 828 the required amounts of the absorbent agent 830 and the adhesive 832. The absorbent-adhesive mixture 820 can then be applied along one or both of the surfaces of the substrate material 822 and the combination attached to the web 802 via the attachment operation 824. Multiple layers of absorbent-adhesive mixtures and substrates may be used.

In other possible manufacturing environments, the mixing operation 828 that premixes the absorbent agent 830 and the adhesive 832 can be eliminated. In such instances, the absorbent agent 830 can be directly applied to web material 802 then coated with the adhesive 832 to secure the absorbent agent in place. The substrate material 822 is then placed over and bonds to the adhesive 832. It is possible in other embodiments to reverse the process by applying first the adhesive 832 to the web material 802 and then applying the absorbent agent 830 over the adhesive. The substrate material 822 can then be placed over and pressed against the absorbent agent 830 forcing adhesive 832 through the adsorbent agent so as to contact and bind to the substrate. The absorbing agent and the adhesive can also be obtained in a pre-mixed form.

After the absorbent-adhesive mixture 820 and substrate material 822 have been attached to the web 802, production of the bag resumes in step 840. The bag manufacturing step 840 can involve various folding, sealing, cutting and perforating operations to manipulate the web 802 into finished bags. The finished bags can remain joined together along perforated side edges such that they can be rolled onto a core in a winding operation 842 for packaging and distribution.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A bag comprising:
a first pliable sidewall;
a second pliable sidewall overlying and joined to the first sidewall to provide an interior volume, the interior volume accessible via an opening disposed between the first and second sidewalls; and
an absorbent-adhesive mixture comprising an absorbent agent and an adhesive, the absorbent-adhesive mixture located in the interior volume.

2. The bag of claim 1, wherein the absorbent-adhesive mixture includes a super absorbent polymer.

3. The bag of claim 2, wherein the super absorbent polymer is sodium polyacrylate.

4. The bag of claim 2, further comprising a substrate located in the interior volume.

5. The bag of claim 4, wherein the substrate is a non-woven material selected from the group consisting of polypropylene, polyethylene, ethylene, nylon, and polyester.

6. The bag of claim 4, wherein the first sidewall, the absorbent-adhesive mixture, and the substrate are layered together.

7. The bag of claim 4, wherein the first sidewall is joined to the second sidewall to provide a first side edge, a parallel second side edge, a closed bottom edge, and an open top edge.

8. The bag of claim 7, wherein the absorbent-adhesive mixture and the substrate extend approximately along the closed bottom edge.

9. The bag of claim 7, wherein the absorbent-adhesive mixture and the substrate extend between the first side edge and the second side edge.

10. The bag of claim 1, further comprising an odor-neutralizing composition.

11. The bag of claim 10, wherein the odor-neutralizing composition is part of the absorbent-adhesive mixture.

12. The bag of claim 1, wherein the first and second sidewalls are comprised of a material selected from the group consisting of high density polyethylene, low density polyethylene, linear low density polyethylene, polypropylene, ethylene vinyl acetate, nylon, polyester, ethylene vinyl alcohol, other polymers, and coextrusions and laminations thereof.

13. The bag of claim 1, wherein the first and second sidewalls are comprised of a first plurality of regions and a second plurality of regions, the second plurality being formed as raised ribs with respect to the first plurality.

14. A method of producing a bag comprising:
(i) providing a web of pliable material;
(ii) mixing an absorbent agent with an adhesive to make an absorbent-adhesive mixture; and
(iii) applying the absorbent-adhesive mixture to the web.

15. The method of claim 14, further comprising the step of:
(iv) applying a substrate to the web.

16. The method of claim 15, wherein the absorbent-adhesive mixture is applied to the substrate prior to applying the substrate to the web.

17. The method of claim 15, wherein the absorbent-adhesive mixture is applied to the web prior to applying the substrate to the web in a position covering the absorbent-adhesive mixture.

18. The method of claim 14, further comprising the steps of:
(v) providing a second web of pliable material; and
(vi) joining the first web to the second web to form a first sidewall and an opposing second sidewall defining an interior volume, the first and second sidewalls being joined along a first side edge, a parallel second side edge, and a closed bottom edge, the interior volume accessible via an opening at a top edge parallel to the closed bottom edge.

19. The method of claim 14, further comprising the step of:
(v) folding the web in half; and
(vi) joining the first web half to the second web half to form a first sidewall and an opposing second sidewall defining an interior volume, the first and second sidewalls being joined along a first side edge, a parallel second side edge, and a closed bottom edge, the interior volume accessible via an opening at a top edge parallel to the closed bottom edge.

20. A bag comprising:
a pliable sidewall providing an interior volume;
an absorbent-adhesive mixture including a super absorbent polymer and an adhesive, the absorbent-adhesive mixture applied to the sidewall; and
a non-woven material formed as a flat substrate, the non-woven material bonded to the sidewall by the absorbent-adhesive mixture.

21. The bag of claim 20, wherein the super absorbent polymer is sodium polyacrylate.

22. The bag of claim 20, wherein the non-woven material is selected from the group consisting of polypropylene, polyethylene, ethylene, nylon, and polyester.

23. An absorbent-adhesive mixture comprising particulates of a super-absorbent polymer mixed in an adhesive.
